(19) United States
(12) Patent Application Publication
(10) Pub. No.: US 2006/0201776 A1
(43) Pub. Date: Sep. 14, 2006

(54) Method and apparatus for retrofitting signage and selection operation of vending machines and the like

(75) Inventors: Gary L. Myers, Monee, IL (US); Richard Paeth, St. Charles, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: TriTeq Lock and Security, LLC, Elk Grove, IL (US)

(21) Appl. No.: 11/430,716

(22) Filed: May 9, 2006

Related U.S. Application Data
(63) Continuation-in-part of application No. 10/908,445, filed on May 12, 2005.
(60) Provisional application No. 60/521,655, filed on Jun. 12, 2004.
(60) Provisional application No. 60/729,852, filed on Oct. 25, 2005.

(51) Int. Cl. G07F 9/10

(52) U.S. Cl. 194/350

(57) ABSTRACT

A method and apparatus serving either as a retrofit kit or new sign front for beverage vending machines to allow the display of product contained in the machine by means of significantly larger product identification indicia than the existing product identification indicia and the display windows are specifically correlated to selection mechanisms associated with the larger windows and may also include numbers, letters, symbols, connecting lines and/or colors. The existing selection operatives are deactivated and a vandal panel corner is optionally applied to the machine to eliminate product selection switches. A circuit board is added that enables increasing the number of product selections and it is adapted to be used with different manufacturer's machines. Reinforcement bar means is optionally provided for the signage panel. A holder may be provided for flavor label cards that is exclusively attached to the rear of the signage. Alternatively, audio and/or visual effects are added to the machine. In a new vendor door the appearance of a center column machine may be established with the sign front and strengthening of the center column panel along with enhancing security of the machine.

### CROSS-REFERENCE TO RELATED APPLICATION

This patent application is a continuation-in-part of U.S. patent application Ser. No. 10/908,445, filed May 12, 2005; which claims the benefit of U.S. Provisional Patent Application No. 60/521,655, filed Jun. 12, 2004. This patent application also claims the benefit of U.S. Provisional Patent Application No. 60/729,852, filed Oct. 25, 2005 and is related to U.S. Design Application Serial No. 29/241,203 filed Oct. 25, 2005. The disclosures of all of which are incorporated herein by reference.

### FIELD OF THE INVENTION

The present invention relates generally to retrofit of signage on vending machines and the like and ultimately manufacturing new machines. More particularly, the invention relates to converting traditional 9-button soft drink vendors to 12-button or other button number vendors.

Soft Drink vending machines manufactured from 1985 through 2001 have a traditional configuration of a large back-lit plastic sign-face decal in the center of the machine (sometimes convex in shape) to advertise the product(s) or brand name of the products in the machine, and a user interface panel consisting of selection buttons, paper currency validator, coin acceptor, debit card reader, and mechanical T-handle lock.

In U.S. Patent Application Publication 2004/0139640 there is disclosed a signage retrofit fit kit for a vending machine which includes a sign having a front side visible by a customer of the vending machine and a rear side facing the vending machine. The sign is attachable to a front portion of the vending machine and has at least one window portion through which an item located on the rear side of the sign can be viewed from the front side of the sign. The window portion is spaced apart from a product identification window of a selection panel of the vending machine and has a size greater than a size of the selection panel product identification window. The kit also includes a holder constructed and arranged to be positioned on the rear side of the sign, the holder is also constructed and arranged to hold a remote product identifier such that the remote product identifier is viewable from the front side through the window portion of the sign. The remote product identifier also is a sized greater than the size of the selection panel product identification window.

The published application retrofit kit has been specifically designed as an improvement on beverage vending equipment produced from 1985 to the present and provides a means of utilizing significantly larger (approximately 5″×7″) remote product identifiers without mechanical alteration to the vending machine. While this is a benefit to the beverage industry in that it transforms a machine with inferior product identification indicia into a vending machine with product identification indicia comparable to new beverage vending equipment and the economic impact is significant, the operation is still lacking in several respects.

A retrofit kit for existing beverage vending machines allows the display of product contained in the machine by means of significantly larger product identification indicia than the existing product identification indicia. However, users may be confused as to where to make the selection for operation of the machine.

An enhanced product identification system for beverage vending machines utilizes a remote holder or product identifiers that correspond to the existing selection buttons on beverage vending equipment, and the selection buttons need to be further coordinated or associated with the enhanced product identification.

The enhanced product identification system for beverage vending machines utilizes a remote holder of product identifiers that correspond to the existing selection buttons on beverage vending equipment and also incorporates a holder of advertising indicia which then has to be changed.

Problems with this configuration are as follows:
1. The product selection switches and the labels that identify what product is vended by pressing what button are very small and aligned vertically in a way that makes it difficult for the customer to see and read what product is available and make the proper selection;
2. The product selection switches require holes in the vending machine door which allow an easy attack point for forced entry for the T-handle lock and the currency;
3. The product selection switch technology is not reliable, and typically only 9 switch positions are provided for a 9 column machine, one switch for each possible flavor (a 9 column machine can allow up to 9 different products to be vended);

The present invention also incorporates several elements of the other version (a back-light sign-face with decals and product selection switches mounted to the sign-face) with a different type of vending machine. It combines these elements with a vending machine such as described and shown in patent number D466,941.

The machine in D466,941 consists of a vendor that primarily re-locates the customer currency interface components (bill validator and coin acceptor) from the right-hand edge of the door to the center column area of the door structure. The product selection buttons (including product selection labels) are typically manufactured of plastic material and are re-located from being exclusively along the right-hand edge of the door to the left and to the right of the center column. These selection switches and labels are larger in size than the switches used in edge locations. Above the center column and the switches are curved sign-faces, one that typically includes the beverage supplier name or logo and below the center column is a curved sign face that typically includes the product delivery chute. The center column typically extends vertically for about three feet at the center section of the door and does not extend either all the way to the top of the door or to the product delivery chute at the lower section of the door. The column itself consists of “U” shaped frame structure of the door and is not separate or removable from the door. The bill validator is typically rigidly mounted to the center column frame of the door. The coin acceptor is located in the center column along with its coin delivery chute. The coin return drop is typically located at the end of the center column several inches above the product delivery chute.

A problem with this configuration is the cost to manufacture or repair the large selection buttons to the right and left of the column. These buttons require a significant amount of mounting hardware and hand-labor to install, costly both for new-manufactured vendors and for repair of vandalized vendors in the field. Another problem is the cover for the center column and the structure that interfaces the top and bottom sign to the center column areas are plastic and or cast aluminum that crack or corrode easily. What is needed is a product that will maintain the attractive appearance with the large flavor selection labels, maintain the center column that includes the currency collection items, maintain the spaced-out location of the product selection buttons, and eliminate plastic and/or aluminum components that easily crack due to abuse. Other problems of this configuration include the center column only extending a limited distance vertically within the door, which limits its strength within the frame of the door. In addition, the center column consists of sheet metal that make up the frame of the door itself, making it non-removable and subject to costly repairs if it is attacked during an act of vandalism. The bill validator mounted to the center column frame is a frequent target of vandalism attacks that will usually include damage to the frame and mounting for the validator, causing an expensive repair of the frame. The validators are rigidly mounted which makes the validator and the frame of the door incapable of absorbing shock from a vandalism attack. Door frames are designed foremost to account for several different validator types and manufacturers, making their mounting alignment and protection from vandalism less than desired. The coin chute in the present location is convenient for users to reach the coins, but due to the short distance from the coin acceptors it is difficult to angle the coin drop to that location. It is also a vulnerable location for collecting dirt.

### SUMMARY AND OBJECTS OF THE INVENTION

The instant invention addresses the needs described above. As shown in FIG. 12, for example, in place of large plastic buttons to the right and left of the column, the invention utilizes a flat or curved sign-face going across both the button and center column area (similar to the sign above the center column). The sign-face can either extend completely across the vendor horizontally, or it may extend partially to one or both edges, or it may extend from one edge to the center column area. In the embodiment where the sign extends to at least partially cover the center column, two signs may be used, one sign extending from the left of the door to the center column, and one sign extending from the right of the door to the center column. Also in this embodiment, as shown in FIG. 14, the center column may be partially or completely exposed, and the sign may be milled with openings to expose the interfaces to the currency collection devices. Individual labels and product selection switches can be mounted on the new sign-face(s) similar as described in previous embodiments of the invention. The product description labels can be attached to the rear of the sign using fasteners or holders on the rear surfaces of the sign face.

The objects of this invention are as follows:
1. Provide larger product identification labels at an easier to read location for each product that can be purchased, and allow these labels to be quickly and reliably attached, removed, and changed in the field by bottler employees and 3rd parties;
2. Provide more selection switches for customers to press than flavors or columns in the machine;
3. Provide a more convenient to use and reliable actuator switch for a customer to select products;
4. Provide enhanced vending machine security from forced entry by eliminating the selection switches (and their respective mounting holes) along the right-edge of the vending machine door;
5. Provide a re-enforced panel to both strengthen the edge of the vending machine door by using this panel to cover a majority of the length of the door (to reduce the potential of bending the door) and to cover the previous holes for the product selection buttons.
6. Provide a label mounting system that would allow for panel distortion without compromising the mounting or proper label placement

### BRIEF DESCRIPTION OF THE SEVERAL VIEWS OF THE DRAWINGS

FIG. 1 is a perspective view of a prior art beverage machine utilizing a generally vertical application as found in the marketplace;

FIG. 2 is a perspective view of a vending machine of one embodiment of the present invention;

FIG. 3 is a perspective view of the configuration utilizing a relocated switch control board and wiring to the switches;

FIG. 4 is a front elevational view of our switch control board;

FIG. 5 is a schematic of one embodiment for the present invention that enables wiring of different models and manufacturers;

FIG. 6 is a chart form description for retrofitting prior art machines to incorporate the present invention by plugging in switch connection to various terminations by provision of jumpers;

FIG. 7 is a perspective partial exploded view of the changeable product decal fastening system;

FIG. 8 is a perspective view of a vendor door which has a horizontal support bar;

FIG. 9 is a perspective view of the horizontal support bar;

FIG. 10 is a perspective view of a vendor door with a vertical bar;

FIG. 11 is a perspective view of the vertical bar;

FIG. 12 is a front view of a vendor door incorporating an alternative embodiment of the present invention;

FIG. 13 is a rear view of the door of FIG. 12;

FIG. 14 is a rear perspective partially exploded view of a vendor door with a removable strong box;

FIGS. 15A, 15B and 15C are plan views of dollar bill validator mountings for three different manufacturer models;

FIG. 16 is a plan view of the rear side of a door;

FIG. 16A is an enlarged perspective view of the DBV mounting in FIG. 16;

FIGS. 17A, 17B and 17C are plan views of three different DBV mounts for comparison;

FIG. 18 is comparative diagrammatic showings of support and label holders and arrangements for vendor doors;

FIG. 19 is another comparative diagrammatic showing of alternative support and label holders for vendor doors;

FIG. 20 is yet another comparative diagrammatic showing of alternative support and label holders;

FIG. 21 is a plan view of the rear side of a door with a different configuration of a flavor card support; and

FIG. 22 is an enlarged plan view of an individual flavor card of FIG. 21.

### DETAILED DESCRIPTION OF THE PREFERRED EMBODIMENTS

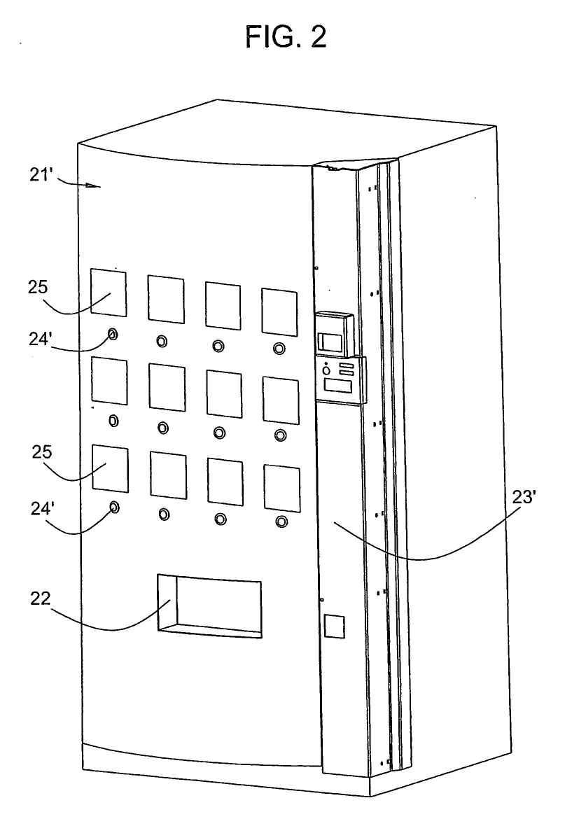

The aforementioned problems created a need to re-locate the product selection buttons over to the new sign-face area that now holds the large product-size decals. Now, a customer can both read and understand what products are available and push the product selection button that is located near (just above, below, or next to) the decal, thus operating like the PepsiCo, D466,941 vending machine. See drawing FIG. 2 for an outline drawing of the vending machine with the preferred 12 new product decals in the sign-face area and with the 12 round selection buttons located under each decal.

The re-location of the product selection buttons created another problem of the holes or cutouts in the vending machine door being empty or vacant, also confusing customers who think the product selection buttons should still be there. Thus, there was a need to cover these holes to discourage a vandal from using these holes to vandalize the vending machine, and to make it obvious to the customer that there are no longer selection switches at that location. Previous to this invention, applicants' assignee, TriTeq Lock and Security, LLC invented a vandal panel for this vintage model vending machine as described in patent applications Ser. Nos. 10/908,445 filed May 12, 2005; 60/521,655 filed Jun. 12, 2004 and D487,777. In these patent applications, it was taught that the panel would cover the majority of the edge of the door in order to discourage bending of the door for forced entry and would provide steel material around the selection buttons on the door to discourage vandals from using tools to break-away buttons. In the new invention described herein, the panel will now completely cover the location where the selection switches were previously located (thus covering the holes or cut-outs in the door that remain) and will usually cover the majority of the edge of the door from top to bottom, thus enhancing the vandalism security even more than in prior versions of this panel. This panel 23′ is shown on the right side of the door in drawing FIG. 2.

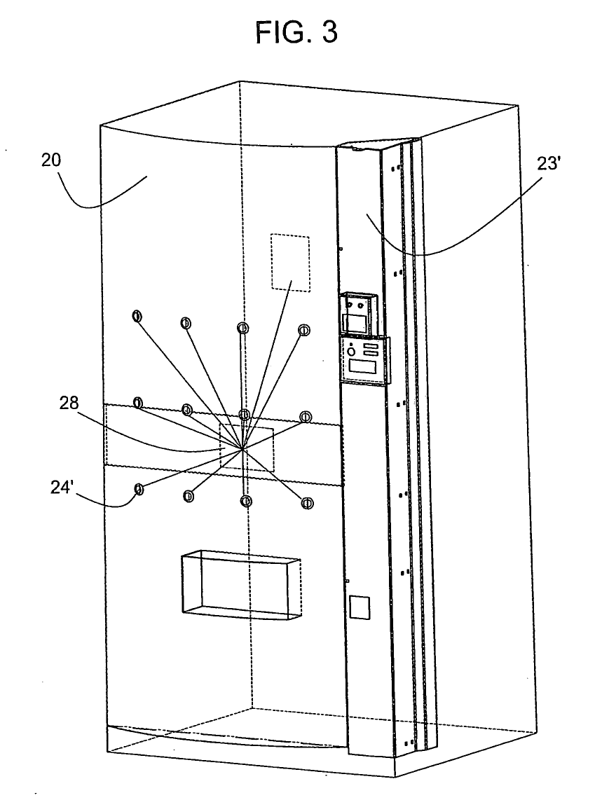

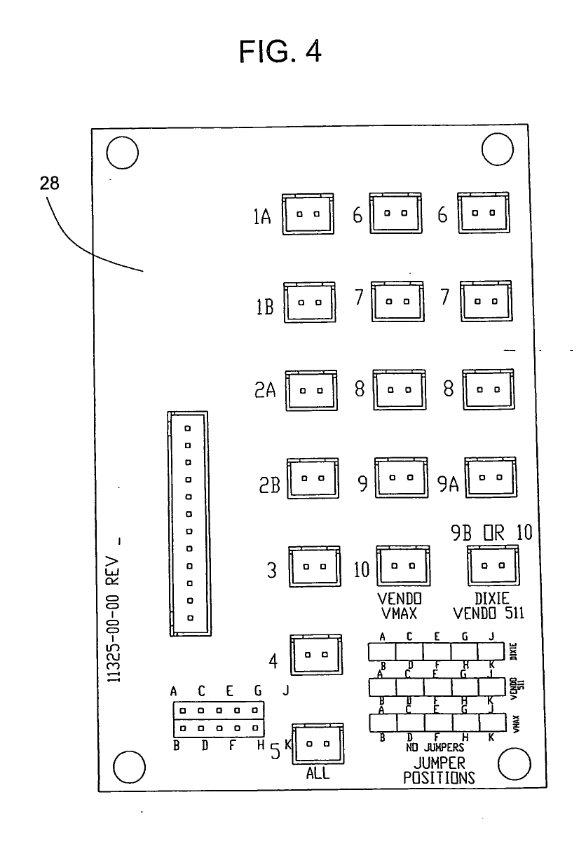

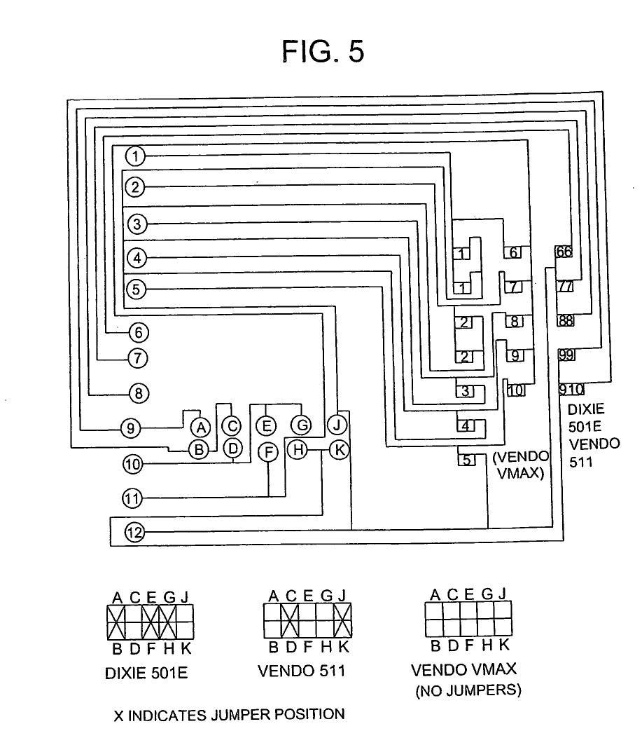

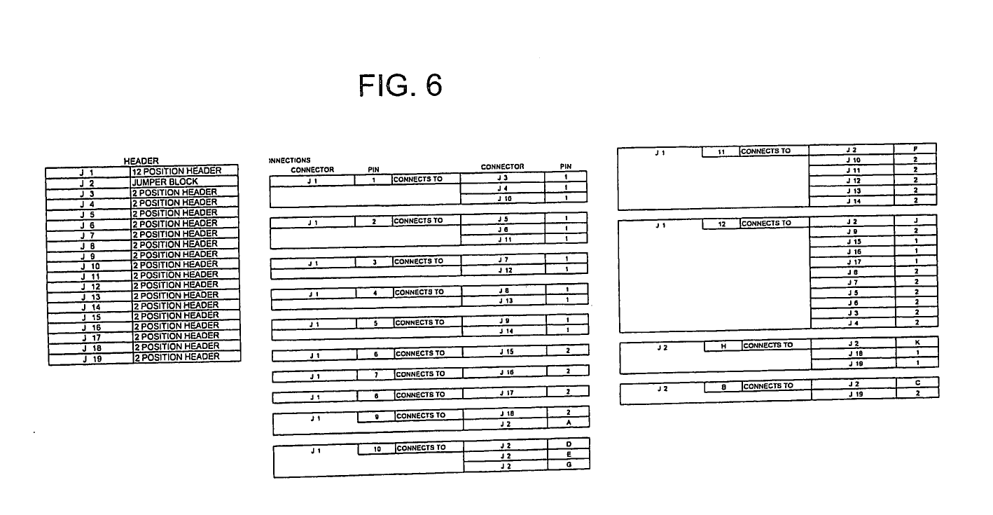

The re-location of the buttons to the sign-face area offers an advantage in that additional product selection buttons can be added to enhance sale-ability of cold-drink products. The PepsiCo vendor of D466,941 has proven that 12 selection buttons in a vending machine that only vends 9 different product brands is an advantage because now up to 3 of the brands can have two or more selection buttons. For example, there may only be one out of 9 columns dedicated to vending Diet Pepsi, but with the new selection button configuration of this invention two (or more) selection buttons may be mounted and electrically wired to the vending control board for Diet Pepsi, giving the customer more than one selection button to press (for example; one selection button may be located on the left of the sign-face and one on the right). A possible location of the switch control board and wiring to the re-located switches is shown in drawing FIG. 3. The switch control board and schematic is shown in drawing FIGS. 4-6. The object of this board is to facilitate the wiring of many different models and manufacturers of vending machines during this era to provide the additional product selection switches to operate for all models. By plugging in the switch connectors to various terminations on the control board facilitates the flavor selection label switch to dispense from various columns. Jumpers are provided on the control board that facilitate the various models of vendors. These jumpers serve to allow one control board to function with a variety of manufacturer's models. An interconnection cable from the control board is provided to allow proper connection to each vendor models

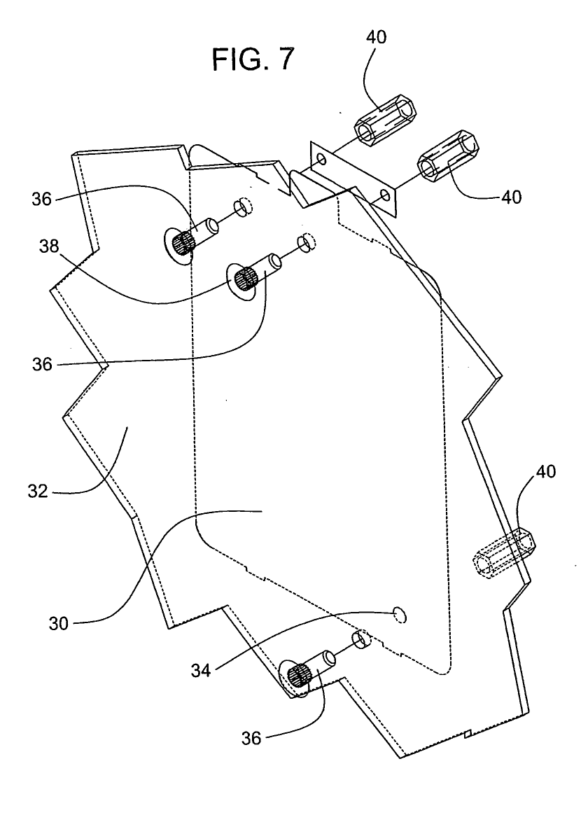

Drawing FIG. 7 is a detail view of the changeable product decal 30 as it is attached to the new sign-face 32 of the invention. The decal 30 attaches inside of the vendor or the inside surface of the sign-face 32. As shown in the figure, the decal 30 has one hole 32 in the lower right corner and a tongue of material 31 protruding at the top of the decal. This invention has at least 2, or preferred 3 fasteners 36 for attaching the decal. These fasteners 36 may have very flat heads 38 so they do not stick out from the outside of the sign-face preventing any scratching a customer. The first (lower) fastener 36 is a screw that goes through the hole 34 in the decal and attaches to a nut fastener 40 on the inside of the sign-face 32. The nut holds the decal to the sign-face inner surface. At the top of the decal, fasteners 2 and 3 (at least one required, two preferred) go through the sign-face and also connect to at least one nut 40 on the inside of the sign-face. The surface of the nut(s) or an optional plastic retainer is used to contact with the decal and hold it in place. The top two fasteners are configured to allow the decal to move. This movement is required when the sign-face is deformed. The deformation cause the decal to slide out from under the plastic or alternately between the nuts. Nuts with grooves under can be also considered as and alternate construction. The top and bottom fasteners can be a common nut and bolt or specialized fasteners using ribbed edges on the circumference to secure them into the sign-face.

In one embodiment such as a refurbishment, shown in FIG. 13, the frame of the center column will stay approximately the size as it exists today on the vendors. In another embodiment, the frame center column will extend higher, possibly to the top edge of the door, and possibly to the product delivery chute or lower, in order to provide additional strength for the door.

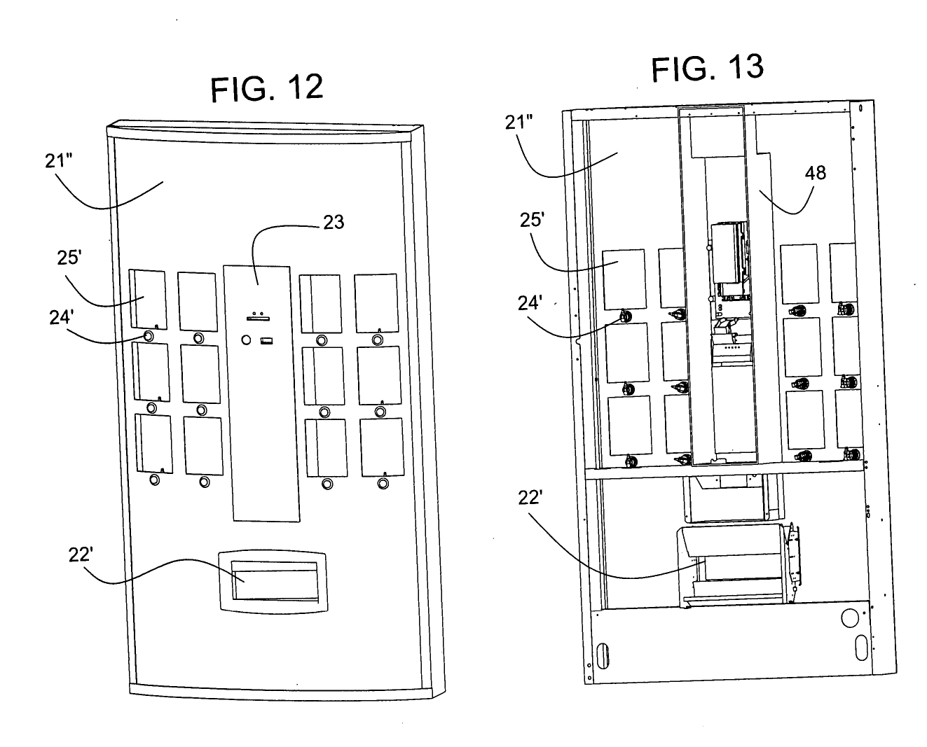

In another embodiment of the invention (for a refurbishment or retrofit application) the existing signs above and below the column may continue to exist unaltered, and the new sign will only extend vertically up to the existing sign(s). In still another embodiment (such as new door manufacturing) shown in FIGS. 12 and 13, the sign would extend to areas vertically that are above and/or below the center column 23 and into the areas of the existing signs. The advantage of this embodiment is that one sign would be used to extend across the door both horizontally and vertically instead of a plurality of signs across the door.

An additional feature of these embodiments where the new sign either partially or completely covers the center column is the application of a cover panel over the new sign (as described in previous embodiments). This panel would act to further protect the currency collection devices (like the center column vandal panels described in previous embodiments). This panel would act to either partially or completely sandwich the new sign or signs with the structure of the center column behind the signs that the currency collection devices are mounted to. This panel would either partially or completely cover the entire center column. This panel would typically fasten to the center column associated with the structure of the door.

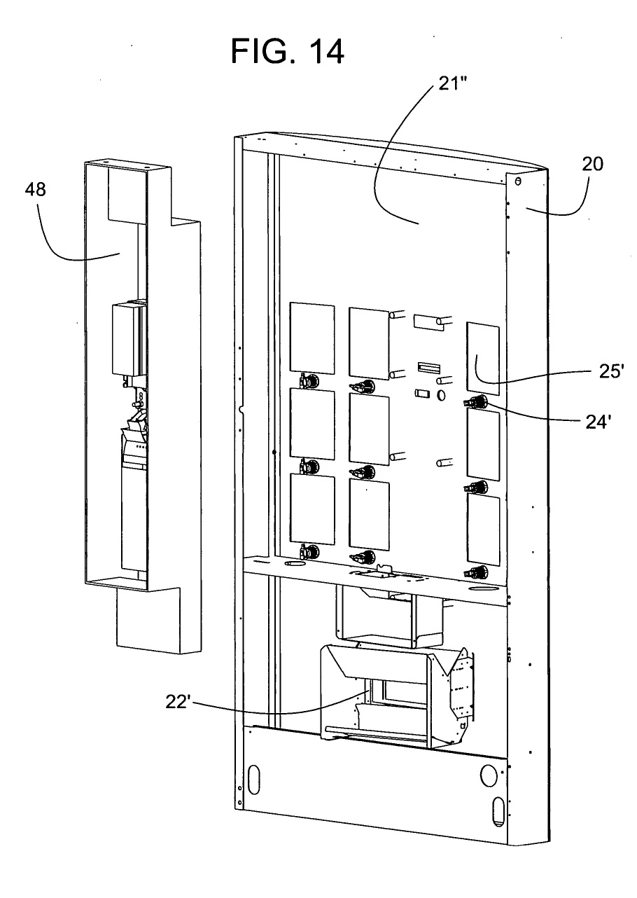

In another embodiment of the invention, the center column will consist of a removable strong-box 48 or structure that can be inserted or removed from the center column frame of the door, see FIG. 14. This strong-box or structure may consist of 3, 4, 5 or 6 sides, and will typically be rectangular in shape to fit into the frame. The strong-box consist of a door for one of it's sides containing of a latch and lock arrangement. The advantage of this box is to 1) provide separate mounting of the currency storage components separate from the center column frame, 2) allow mounting of these components in a separate labor operation away from the vending machine, and next allow the complete installation of the strong-box and currency components in one separate operation. Lastly, if the vendor and strong-box is attacked by vandals, the strong-box can be easily replaced by a new strong-box with little or no repair required for the center column frame.

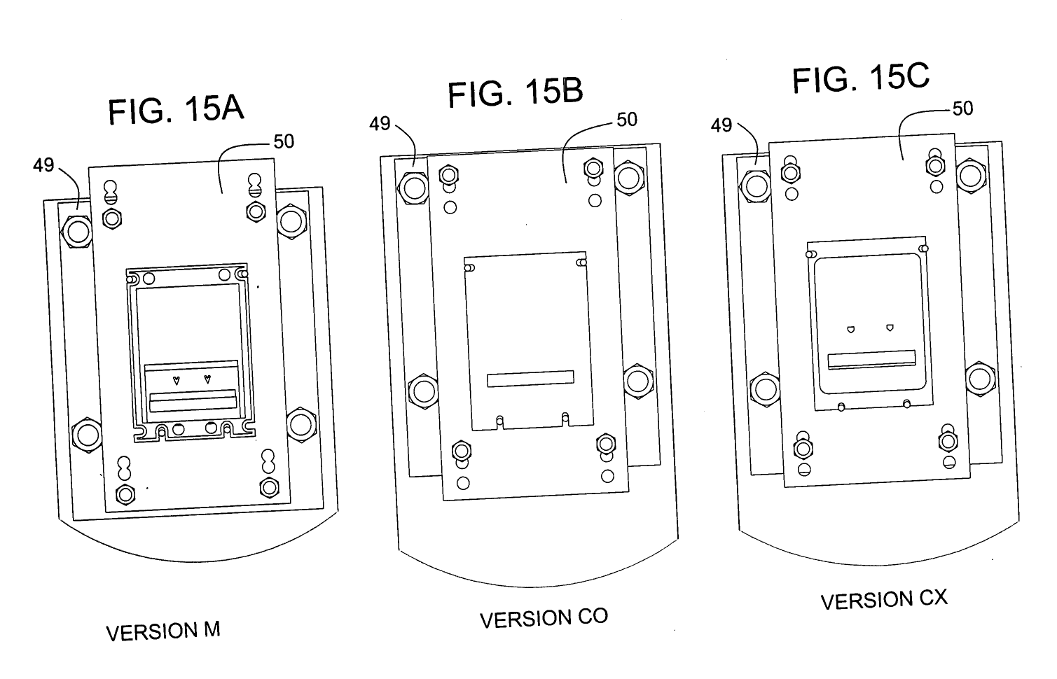

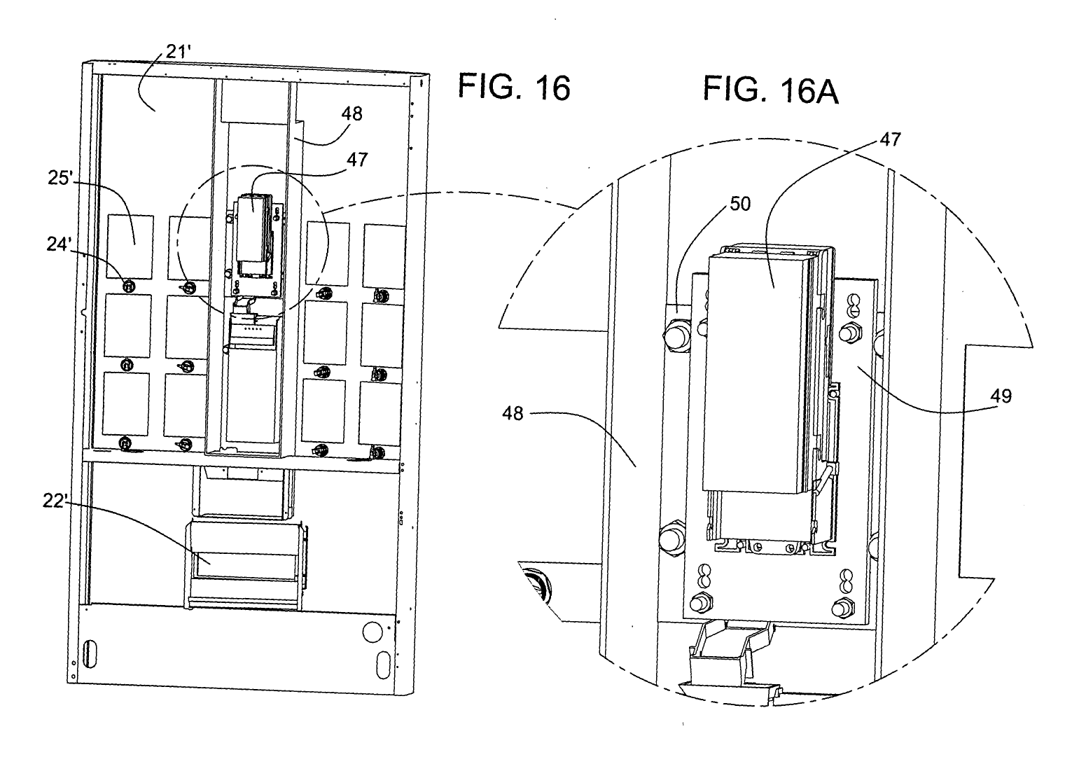

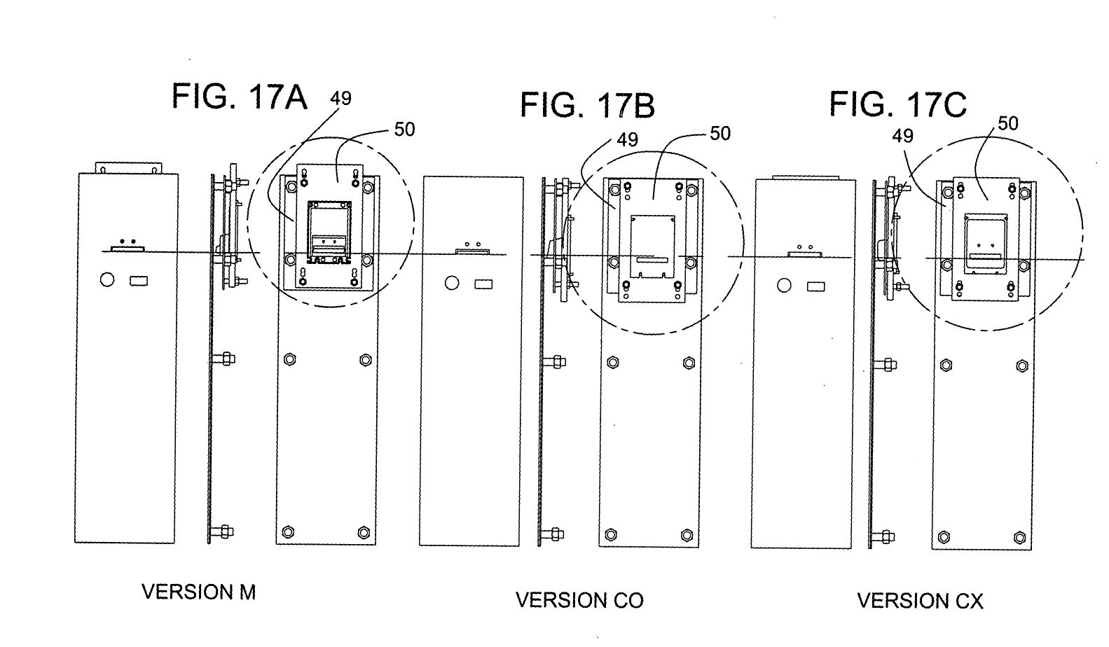

In still another embodiment, as shown in FIGS. 15, 16 and 17 A, B, C, the dollar bill validator is mounted to a separate mounting plate 49 in the center column. This plate is attached to the frame by large bolts to insure the frame will not be damaged during an attack. In an attack the validator and the plate may be damaged while the damage to the frame is minimal or non-existent, and both the validator and the plate can be easily replaced by removing/installing a new plate to the frame. In addition, the mounting of the plate to the frame may also include springs under tension in order to provide a shock-mount 50 from the plate to the frame. Under attack, the shock-mounts can absorb some or all of the force, thus reducing the damage to the validator, plate and frame. In addition to the above-described features of the currency collector mounting plate, the plate allows more than one type or model of currency acceptor device to be mounted to it. The plate provides an adjustment feature of allowing the currency collector to be shifted within the column in any one or more or the combination of 6 directions or positions in the x, y, and z direction thus compensating and allowing for the different shapes and dimensions of the different models to each properly mount within and protruding from the column.

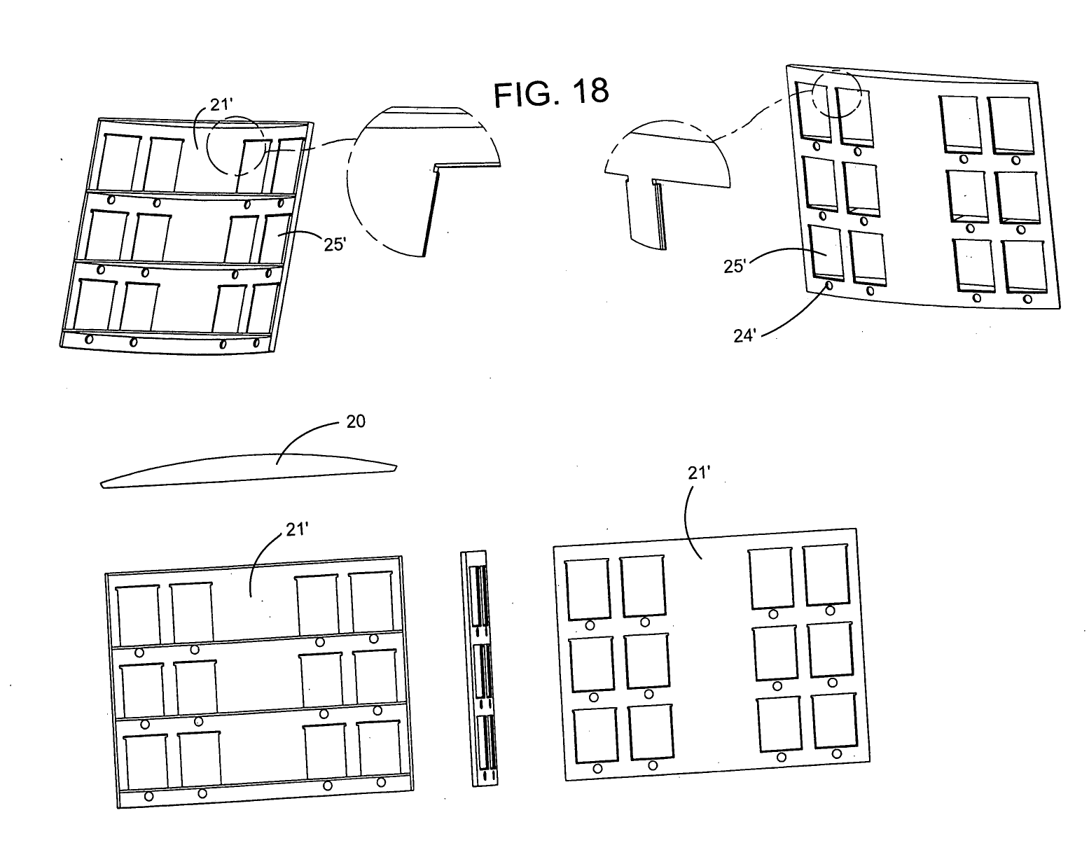

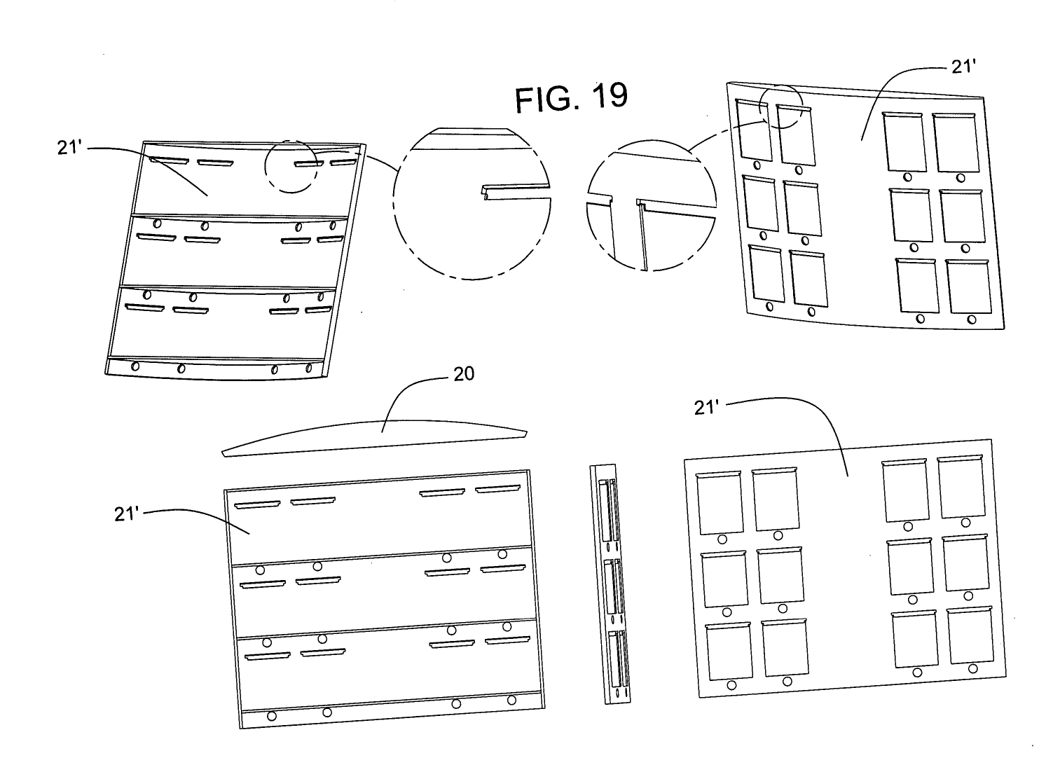

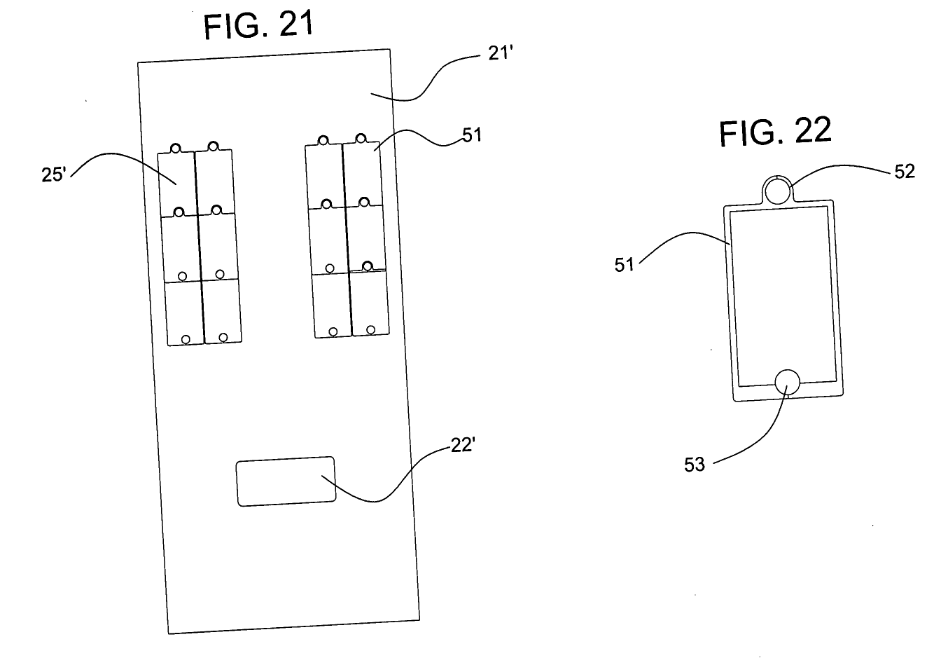

In a further embodiment, shown in FIG. 21, the invention utilizes flavor cards of a different configuration than the typical flavor cards used in the previous embodiments. The advantages to these cards are as follows: The present labels are typically 10 mils thick so they can support themselves inside the buttons. A label that is held within holders as shown in FIGS. 18-20 can be thinner for example 5 mils. It is desirable to mask or darken the areas around the perimeter of the flavor labels for cosmetic purposes. This darkening can be achieved using new geometry for the labels, this geometry would use an over lapping systems to achieve the desired results. Another masking or darkening solution can come from utilize an alternate mounting frame to hold the labels and provide the masking effect. These cards 51 may also provide a mounting hole 52 or slot 53 as shown in FIG. 22. This hole or slot may interface to a product selection switch mounted to the signfront. Thus, the mounting of the product selection switch can also be utilized as at least one mounting fastener or holder for one or more flavor cards, thus eliminating the holder in FIGS. 18-20. If no holder is utilized, the thickness of the label may be required to be 10 mils.

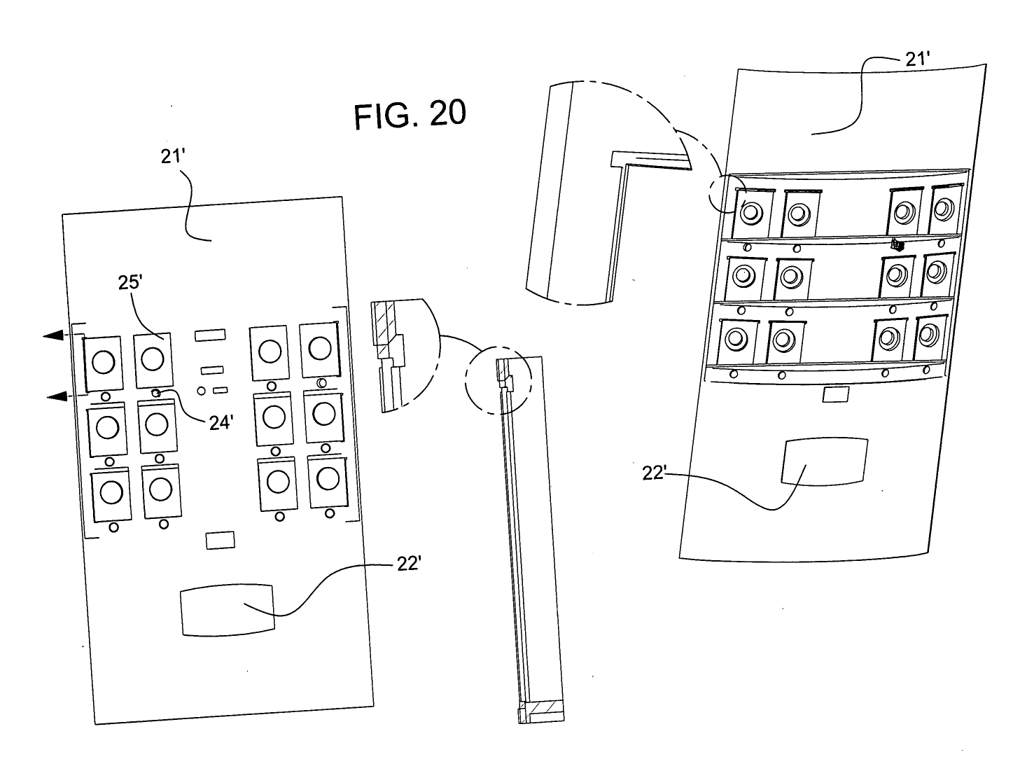

In still another embodiment, shown in FIGS. 18, 19 and 20, the invention provides a holder for the flavor label cards which is an improvement to the prior art, in particular Myatt US2004/0139640. This holder can be an apparatus that is located behind the external sign-face attached to the door and the holder is attached exclusively to the rear-side of the sign. The holder may be made of rigid material such as a molded plastic structure and slightly curved to accommodate the curve of the sign. In the rigid embodiment, the holder will also serve to provide a stiffening structure so that pressing of the product selection buttons mounted on the sign will not cause the convex shaped sign to flex inwardly. In another embodiment shown in FIG. 20 the holder may be flexible such as a flexible sheet of plastic in order to be less costly. In one embodiment, shown in FIG. 18-20 the new holder will be attached primarily by using the product selection switches as fasteners for the holder. In other embodiments it may be attached by fasteners or by a combination of the switches and fasteners. Other features of the holder may include utilizing the mounting frame as shown in FIGS. 18-20 to hold the labels and provide the darkening effect.

In another alternative embodiment the coin return slot is re-located to an area that is several inches lower than located on the machine today. It would be located in an area that is much closer to the product delivery chute, thus improving the delivery of the coin from the coin changer.

A further embodiment of this invention, includes a sign comprising an area that is translucent so a customer could view the operation of the vending machine mechanism. This area could be complimented with lights behind the sign that would attract a customer to look inside the vending machine while a product is being vended.

In an alternative embodiment of this invention, the traditional florescent light that will traditionally completely backlight the sign would be either replaced or supplemented with locally and strategically placed individual lights that would selectively back light certain areas of the sign or the labels attached to the sign. These lights could be individually controlled to illuminate in a certain sequence(s) depending on if the machine is in a pre-vending mode, in the process of vending, or in a post-vending mode of operation. In addition, individual lights could be placed behind the product identification decals and selectively illuminated, flashed, or not-illuminated to indicate a product is either sold-out or in the process of vending. Cold cathode bulbs (for example 4″ or so in length) or LED or other light sources are examples of the individual light sources.

In yet another embodiment, the product selection switches now mounted to the sign can employ lights to illuminate the button (pressed for a product selection) of the switch. As described above for the decal lighting, these lights could be individually controlled to illuminate in a certain sequence(s) depending on if the machine is in a pre-vending mode, in the process of vending, or in a post-vending mode of operation. In addition, individual lights could be selectively illuminated, flashed, or not illuminated to indicate a product is either sold-out or in the process of vending. LED lights would be a typical example of the individual light sources for the buttons.

In a further embodiment of the invention, a sound producing device such a speaker and a sound generator can be employed to randomly produce sounds that will attract potential customers of the vending machine, and can also be controlled to produce additional specific sounds depending on which product selection button is pressed.

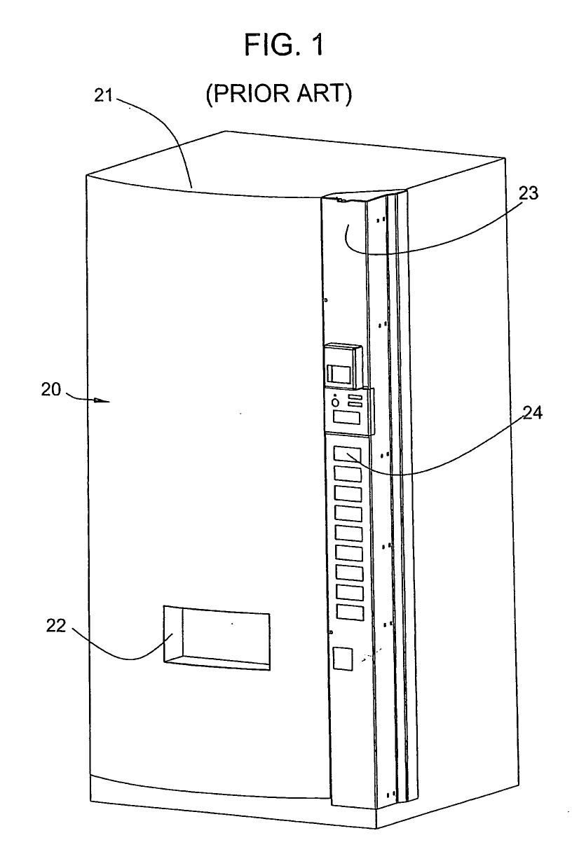

Drawing FIG. 1 shows the traditional soft drink vending machine manufactured from the 1980's through year 2001. A large convex sign-face decal area is above the product delivery chute, and the customer interface vertical column is along the right-hand edge of the vending machine door.

Since 2001 many of the manufacturers changed their vending machines to large button configuration where the product selection buttons are located more in the sign-face area or center of the machine and are larger, about the size of the products they intend to vend. For examples, see patent numbers D466,941 (PepsiCo, Inc. version) and U.S. Pat. No. 6,230,426 (The Coca-Cola Company version). These newer machines with the larger buttons have proven to be more effective than the older machines in selling products and, in some situations, in curtailing forced entry vandalism.

Due to the large number of the older vending machines in the field (such as shown in drawing FIG. 1) it is advantageous to convert the older machines to utilize the features and benefits of the newer machines so less older machines need to be scraped and obsolete. This conversion consists of replacing the original center sign-face with a new center sign-face that will hold product selection labels that can be easily mounted and removed. Several inventors succeeded in doing this, see US2004/0139640 (Myatt), U.S. Pat. No. 6,023,870, and US 2004/0128889, but their attachment apparatus and methods have not proven to be as fast, convenient, or reliable as the vending machine operators have expected.

In addition, the new sign-face as described in Myatt has created confusion among customers in it's application because it looks like the vending machine described and introduced by PepsiCo in D466,941 wherein the selection buttons are re-located to the sign-face area, but the Myatt invention still operates using the product selection buttons along the right side edge, see location 2 on the cover page of the publication. Thus, customers already familiar with the new PepsiCo D466,941 vendor become confused when operating the invention.

Referring to the drawings in more detail, FIG. 1 (Prior Art) depicts the front of a typical beverage vending machine 20. The front of a typical beverage vending machine may include a printed, generally full-length sign 21, usually of semi-flexible plastic typically held to the machine in a known manner by trim pieces and illuminated by lighting positioned in the interior of the vending machine. Product is selected by utilizing a vertical, selection panel 23 that is located to the right side of the front of the machine. The selection panel 23 includes small, rectangular product identification windows 24 through which product indicia of the corresponding product contained within the machine can be viewed. The windows 24 can incorporate switches, or separate switches in the form of buttons can be provided adjacent the windows, as is known, so that product is selected by pushing either the actual window 24 or a button adjacent to the window. A consumer must currently make a selection based solely on the small, rectangular product indicia associated with each window 24.

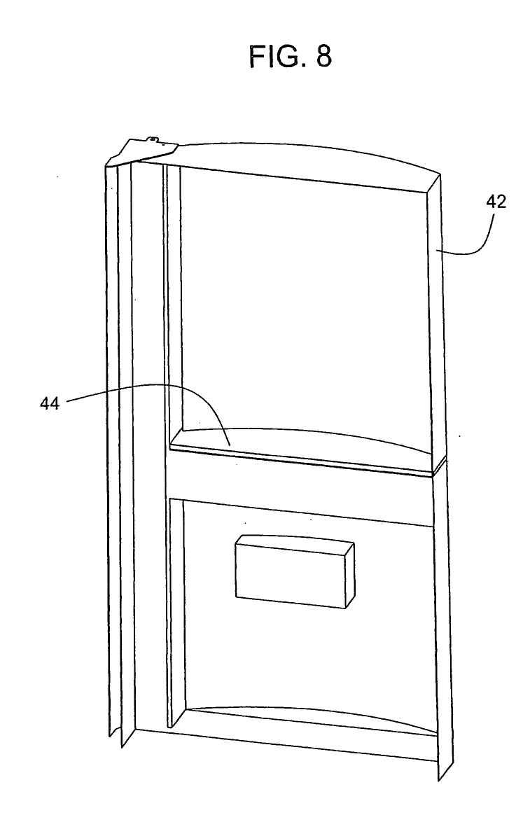

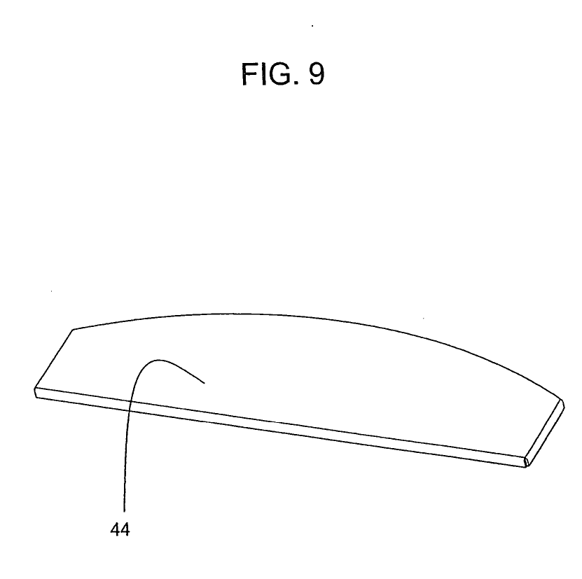

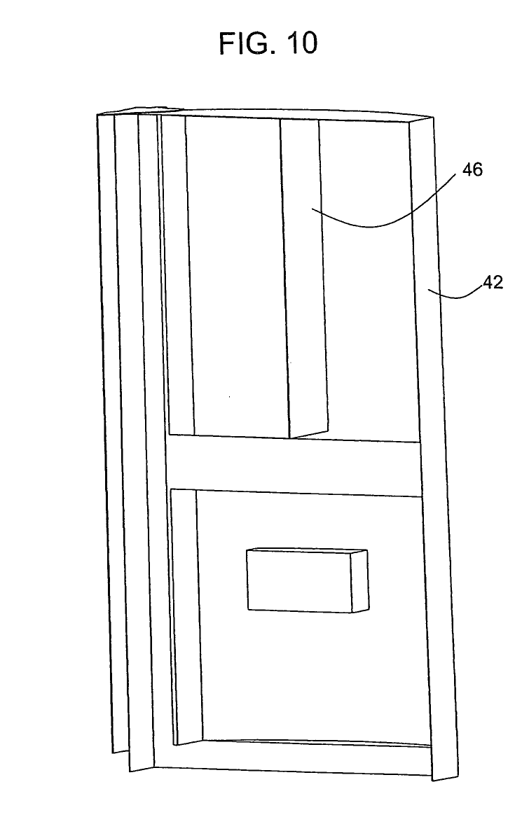

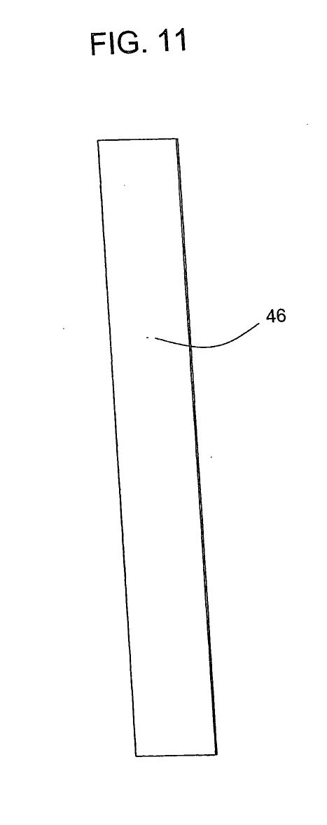

An additional feature as shown in drawing FIGS. 8-11 is to add strengthening bar 44, 46 (or bars) that would either run vertically or horizontally (or both) behind the decals and switches to keep the curved lexan panel from flexing when a customer pushes a button.

In an alternative embodiment, a retrofit (or modification at the factory) the traditional vendor design such as described in patent D466,941 is by removing the individual lexan buttons and hardware and mounting the buttons and the plastic cover of the center column, and installing a single curved or flat lexan panel with the labels attached to the panel and mount the individual switches to the panel. The advantage to this configuration would be to construct the large buttons to the sheetmetal door and instead replace the lexan buttons with a single lexan panel with flavor labels and simpler to mount selection switches. Since the vendor has the customer interface area (bill validator, coin acceptor, etc) in the center column, this cover would be removed also and the lexan panel would now cover the center column and provide cut outs for the bill validator, coin acceptor, etc. The difference between this embodiment and the earlier embodiments is that the vendor provides the customer interface in the center column and machine. The customer still has the customer interface in the original area along the right edge of the door.

In accordance with the present invention, a retrofit kit can be supplied for various types of older style vending machines that allows the upgrading of the appearance of the machine to a style similar to the marketing graphics of new vending machines merely by the replacement of the existing sign 21 with the present invention sign/holder assembly as described above and, optionally, the graphics associated with the selection panel 21 and selection panel windows 25 and buttons 24. The only modifications to the vending machine or other components needed to retrofit the older style machine are disconnecting the previous selector button wiring and connect the new selector operators. The cost of the retrofit is but a fraction of the cost of the replacement of the machine. The present invention retrofit kit uses the machine's existing signage lighting and can be installed on the vending machine with the same tools required to change the sign 21 and in approximately the same amount of time. Thus, the preferred new style marketing graphics can be used on an older style vending machine without incurring the cost of replacing the entire vending machine. Since signage is routinely replaced at 3-5 year intervals, the cost of the retrofit can be further reduced by retrofitting machines at the time signage replacement would be otherwise desired or required (including signage replacement required because of damage or vandalism to the sign). Graphics for the holder openings, selection panel 21 and buttons 24 are easily replaceable, either as group units or individually, to change images and/or product selections.

It is intended that aspects of the invention as described above can be used in any number of different combinations and permutations.

It should be understood that various aspects of the present invention may be combined in a variety of ways such as different flavor card or decal attachments may be used with the product selection buttons, circuit board, panel center column or vandal panel or other features. The sign face panel may have a holder arrangement attached to its rear side or additional panels may be provided, such for example as in Chirnomas et al. Pub. No. US 2004/0128889 published Jul. 8, 2004. Craven U.S. Pat. No. 5,255,968 had an outer panel and an inner sign face panel that may be removed and replaced. Chirnomas added replaceable flavor cards to the second panel. Myatt et al. US 2004/0139640 provided an improved holder for flavor cards. Applicant has disclosed here several alternative holder arrangements. Thus, unless otherwise stated in the claims, it is applicants' intention to include various different versions of attachments for flavor cards or decals within the scope of its broadest claims.

1. A method of upgrading existing vending machines and the like wherein said vending machines have illuminated signage on the door front, product selection buttons associated with particular products and switching circuitry means for operating the machine, comprising the steps of;
providing a signage panel for placement on the front of a vending machine;
supplying a signage panel with enhanced product identification signage having large windows displaying available products and selection buttons,
installing selection operating means associated with the enhanced product identification windows;
and making the number of available selection switches useable with the machine coincide with the product display windows.

2. A retrofit kit for performing the method of claim 1.

3. A method as claimed in claim 1 wherein reinforcement means is added to underside of the signage panel.

4. A method as claimed in claim 1 wherein a changeable product decal is provided and attachable to the inner side of the signage panel.

5. A method as claimed in claim 1 including a changeable product decal for the vending machine sign panel comprising a decal means and fastening means for attachment and removal of the decal on the inside of the sign panel.

6. A method as claimed in claim 1 including applying a corner vandal panel to the machine.

7. A method as claimed in claim 1 or claim 6 including the provision of audible or visual effects to the machine.

8. A method as claimed in claim 1 wherein the number of available selection switches useable with the machine is increased over the number of separate products dispensed by the machine.

9. A door for use in vending machines comprising:
a door with a vertically oriented substantially central column area for holding customer interface means, at least one sign panel covering at least a portion of the front surface of the door over the vertical column, a panel attached to the door in the area of the vertical column, and said panel overlaying at least one surface of said sign panel.

10. A vending machine door as claimed in claim 9 wherein product decal labels are located behind the sign face.

11. A vending machine door as claimed in claim 9 wherein the decal labels are removably attached to the sign panel.

12. A vending machine door as claimed in claim 9 wherein the decal labels are held by a holder that is attached to the sign panel.

13. A vending machine door as claimed in claim 9 wherein product selection switches are attached to the sign panel.

14. A vending machine door as claimed in claim 9 wherein the sign panel covers a majority of the door surface.

15. A vending machine door as claimed in claim 9 wherein the sign covers a majority of the vertical column surface.

16. A vending machine door as claimed in claim 9 wherein the vertical panel covers a majority of the vertical column surface.

17. A vending machine door as claimed in claim 9 wherein the sign panel includes product display decals and separate product selection buttons.

18. A vending machine door as claimed in claim 16 wherein the decals and buttons are disposed on opposite sides of the center column area.

19. A method as claimed in claim 1 wherein the door includes a central column area.

20. A method as claimed in claim 19, wherein said central column area is provided with an opening at least partially exposing the machine central column.

21. A vending machine door as claimed in claim 10 wherein said product labels are removably attached to a separate panel located behind the sign panel and said labels are viewable through windows in the sign panel.

22. A vending machine door as claimed in claim 9 wherein the central column area includes a strong-box structure attached behind the sign panel.

23. A vending machine door as claimed in claim 9 wherein a currency validator is mounted to a separate plate attached in the center column area.

24. A method of upgrading existing vending machines and the like wherein said vending machines have illuminated signage on the door front, product selection buttons associated with particular products and switching circuitry means for operating the machine, comprising the steps of;
providing a signage panel for placement on the front of a vending machine;
providing product selection switching circuitry means for connection to the machine front;
supplying a signage panel with enhanced product identification signage having large windows displaying available products and selection buttons, and
installing selection operating means associated with the enhanced product identification windows;
and making the number of available selection switches useable with the machine coincide with the product display windows.

25. A retrofit kit for performing the method of claim 24.

26. A method as claimed in claim 24 wherein reinforcement means is added to underside of the signage panel.

27. A method as claimed in claim 24 wherein a changeable product decal is provided and attachable to the inner side of the signage panel.

28. A method as claimed in claim 24 including a changeable product decal for the vending machine sign panel comprising a decal means and fastening means for attachment and removal of the decal on the inside of the sign panel.

29. A method as claimed in claim 24 including applying a corner vandal panel to the machine.

30. A method as claimed in claim 24 or claim 29 including the provision of audible or visual effects to the machine.

31. A method as claimed in claim 24 wherein the number of available selection switches useable with the machine is increased over the number of separate products dispensed by the machine.

32. A door for use in vending machines comprising:
a door with a vertically oriented substantially central column area for holding customer interface means, at least one sign panel covering at least a majority of the front surface of the door to one side and/or both sides of the vertical column, a panel attached to the door in the area of the vertical column, that has a front surface outwardly curved from the sign panel front surface.

33. A vending machine door as claimed in claim 32 wherein product decal labels are located behind the sign face.

34. A vending machine door as claimed in claim 32 wherein the decal labels are removably attached to the sign panel.

35. A vending machine door as claimed in claim 32 wherein the decal labels are held by a holder that is attached to the sign panel.

36. A vending machine door as claimed in claim 32 wherein product selection switches are attached to the sign panel.

37. A vending machine door as claimed in claim 32 wherein the sign panel covers a majority of the door surface.

38. A vending machine door as claimed in claim 32 wherein the sign covers a majority of the vertical column surface.

39. A vending machine door as claimed in claim 32 wherein the vertical panel covers a majority of the vertical column surface.

40. A vending machine door as claimed in claim 32 wherein the sign panel includes product display decals and separate product selection buttons.

41. A vending machine door as claimed in claim 39 wherein the decals and buttons are disposed on opposite sides of the center column area.

42. A method as claimed in claim 24 wherein the door includes a central column area.

43. A method as claimed in claim 42, wherein said central column area is provided with an opening at least partially exposing the machine central column.

44. A vending machine door as claimed in claim 33 wherein said product labels are removably attached to a separate panel located behind the sign panel and said labels are viewable through windows in the sign panel.

45. A vending machine door as claimed in claim 32 wherein the central column area includes a strong-box structure attached behind the sign panel.

46. A vending machine door as claimed in claim 32 wherein a currency validator is mounted to a separate plate attached in the center column area.
